(19) United States
(12) Patent Application Publication
(10) Pub. No.: US 2002/0106609 A1
(43) Pub. Date: Aug. 8, 2002

(54) Dental forceps

(76) Inventors: Rosanne M. Palermo, Erie, PA (US); Albert E. Straus, Timonium, MD (US)

Correspondence Address: EDWARD W. GOEBEL, JR., MACDONALD, ILLIG, JONES & BRITTON LLP, 100 STATE STREET, SUITE 700, ERIE, PA, 16507-1498, US

(21) Appl. No.: 10/068,380

(22) Filed: Feb. 5, 2002

Related U.S. Application Data
(60) Provisional application No. 60/266,783, filed on Feb. 6, 2001.

(51) Int. Cl. A61C 3/14

(52) U.S. Cl. 433/159; 294/99.2

(57) ABSTRACT

An improved dental forceps has a pair of gripping distal tips for placing and removing articles such as metal bands, strips, and soft cotton pellets on and from teeth. A plane of orientation is defined by the longitudinal axes of two elongated legs which are biased apart from each other at one end when the legs are not being squeezed. At the end of each leg is a gripping distal tip, with both distal tips deviating at an angle from the legs' longitudinal axes toward the outside surface of one leg and away from the outside surface of the other leg, while staying approximately within the forceps' plane of orientation. Due to this planar orientation of the distal tips, less twisting of the wrist is necessary while using the forceps, thereby reducing the risk of radio-carpal conditions, especially after long periods of use. The distal tip of each leg has a curved inside surface such that the gripping space is formed between the surfaces when the legs are not being squeezed. Since the direction of forceps gripping is parallel to the forceps' plane of orientation, the major line of the gripping action is approximately contained across this plane. When the practitioner squeezes the forceps, the curled, inside edges of the distal tips exert a gripping action that produces a longitudinal or sliding motion between the distal tips as the practitioner varies the tightness of the squeezing action. The ability to effect this motion tends to increase sensitivity and fine control in gripping.

This application claims the benefit of U.S. Provisional Application No. 60/266,783 filed on Feb. 6, 2001, which is incorporated herein by reference.

### BACKGROUND

This invention relates to the field of dental forceps, such as those used by dental professionals, for use in dental procedures. More specifically, this invention relates to forceps useful for the placement and removal of articles such as metal bands, strips, and soft cotton pellets on and from teeth.

There are many types of forceps available to dental practitioners that are useful in performing various types of dental procedures. However, many of these devices compromise dexterity and comfort for the user, who is normally a dental practitioner. Forceps are normally comprised of two squeezed members or legs which define a plane of orientation. Previous forceps have included distal tips positioned at approximately 45° angles from this plane of orientation. Due to the geometries associated with a patient's mouth and jaw, such previous devices often require awkward positioning of the practitioner's hand and wrist. In such circumstances, it is common for a practitioner's wrist to be turned as much as 90° from its relaxed position. Depending on the particular procedure involved, it may be necessary for the practitioner to maintain this awkward positioning for extended periods.

It is commonly known that repetitive tasks performed at deviations from relaxed anatomical positions can result in fatigue, discomfort, and possible carpal syndromes ultimately requiring medical attention and treatment. However, previous forceps designs have been limited in that they cannot be used properly without subjecting practitioners to such awkward arm and wrist positioning. It follows that such instruments pose a continued potential for physical injury to their users, especially after extended or repeated use. Awkward arm and wrist positioning also tends to obstruct the practitioner's visual field, further complicating various dental procedures.

Some previous designs have attempted to reduce the amount of gripping required by having a construction that makes them self-closing. In these designs, the resiliency of the interconnection between the separate legs biases the forceps in their closed position. Such designs are arranged so that external pressure applied to the forceps by squeezing the legs together at a point near the point of interconnection serves to draw the distal tips apart from each other, thereby releasing gripping action of the tips' inside surfaces. However, such configurations are significantly limited in the amount of gripping force that can be exerted by the forceps legs, such force being restricted to the biasing force of the legs' interconnection. It is not possible for a practitioner to increase the gripping force of such forceps by squeezing harder or by applying additional pressure. This can prove to be a significant problem in certain situations. For example, during the placement of an interproximal strip or band in tight contact, the strip or band can slip out of the distal tips, making the procedure difficult for the practitioner. Moreover, while such designs may reduce the amount of positive gripping force required to perform a gripping operation, or while such designs may shorten the duration of the required manual squeezing, they do not eliminate the need for the practitioner to at least momentarily and repeatedly position the hand in an awkward position.

Previous forceps have been further limited by the fact that the relative positioning of their distal tips remains constant when closed. In most previous designs, squeezing the forceps forces the inside portions of each leg to meet at a particular gripping surface near the legs' distal tips. Once the gripping surfaces meet, neither of the distal tips slide relative to the other regardless of the amount of force the practitioner applies. If the practitioner squeezes harder, a tighter grip may or may not result, but there will be no additional relative movement between the gripping surfaces. Accordingly, there will be no improvement in the practitioner's tactile sensitivity and control. This limitation can also make it difficult for the practitioner to fully manipulate certain dental elements to be positioned in the tight confines of a patient's mouth. In addition, excessive squeezing pressure against the legs can force the distal tips apart, resulting in reduced gripping force and the loss of tactile control of gripped objects.

### SUMMARY

The present invention is an improved dental forceps having a pair of gripping distal tips for placing and removing articles such as metal bands, strips, and soft cotton pellets on and from teeth. It is an object of the invention to reduce fatigue, discomfort, carpal syndromes, and other adverse physical effects associated with prolonged or repetitive dental procedures that require a practitioner to orient the hand in an awkward or deviated position. In allowing for the less awkward orientation of a practitioner's arm and wrist, it is also an object of the invention to increase a practitioner's visual field during use.

The invention includes two elongated legs in springing connection at one end and biased apart from each other so that a gripping space exists between the other end of the legs when the legs are not being squeezed. A plane of orientation is defined by the longitudinal axes of the two legs. At the end of each leg is a gripping distal tip, with both distal tips deviating at an angle from the legs' longitudinal axes toward the outside surface of one leg and away from the outside surface of the other leg, while staying approximately within the forceps' plane of orientation. Due to this planar orientation of the distal tips, less twisting of the wrist is necessary while using the forceps, thereby reducing the risk of radio-carpal conditions, especially after long periods of use.

The distal tip of each leg has a curved inside surface such that the gripping space is formed between the surfaces when the legs are not being squeezed. Since the direction of forceps gripping is parallel to the forceps' plane of orientation, the major line of the gripping action is approximately contained across this plane. When the practitioner squeezes the forceps, the curled, inside edges of the distal tips exert a gripping action that produces a longitudinal or sliding motion between the distal tips as the practitioner varies the tightness of the squeezing action. The ability to effect this motion tends to increase sensitivity and fine control in gripping.

The invention also includes a self-locking mechanism on the inside surfaces of the legs of the forceps. The self-locking mechanism is configured to engage and lock the forceps in a closed position after the practitioner squeezes the forceps fully. The self-locking mechanism maintains the forceps in the closed position until the practitioner manually releases the mechanism.

Various other features, advantages, and characteristics of the present invention will become apparent to one of ordinary skill in the art after reading the following specification. This invention does not reside in any one of the features of the forceps disclosed above and in the following Detailed Description of the Preferred Embodiments and claimed below. Rather, this invention is distinguished from the prior art by its particular combination of features which are disclosed. Important features of this invention have been described below and shown in the drawings to illustrate the best mode contemplated to date of carrying out this invention.

Those skilled in the art will realize that this invention is capable of embodiments which are different from those shown and described below and that the details of the structure of this automatic lock can be changed in various manners without departing from the scope of this invention. Accordingly, the drawings and description below are to be regarded as illustrative in nature and are not to restrict the scope of this invention. The claims are to be regarded as including such equivalent automatic locks as do not depart from the spirit and scope of this invention.

### BRIEF DESCRIPTION OF THE DRAWINGS

For a more complete understanding and appreciation of this invention and many of its advantages, reference should be made to the following, detailed description taken in conjunction with the accompanying drawings wherein:

FIG. 1 is a perspective view of a typical dental forceps according to the invention, depicting distal tips angled approximately within the legs' plane of orientation and having a single piece locking mechanism;

FIG. 2 is a perspective view, for comparison with the novel forceps of FIG. 1, of prior dental forceps depicting distal tips angled away from the legs' plane of orientation;

FIG. 3 is a perspective view of an embodiment of the invention having a pawl locking mechanism;

FIG. 4 is a perspective view of an embodiment of the invention having a sliding block locking mechanism;

FIG. 5 is a top view of the dental forceps of FIG. 4 showing the profile of the apparatus being contained within the legs' plane of orientation;

FIG. 6 is a cross sectional side view of the forceps of FIG. 4 showing angled distal ends of each leg and also showing the assembled components of the sliding block locking mechanism according to one embodiment of the invention;

FIG. 7 is an exploded, perspective view of the forceps of FIG. 4 further representing the individual components of the sliding block locking mechanism according to one particular embodiment of the invention;

FIG. 8A is side view of the forceps of FIG. 7 depicting the outside surfaces of the legs being squeezed so that the curled inside edges of the distal tips begin to contact each other, the sliding block locking mechanism being disengaged;

FIG. 8B represents the same view of the forceps depicted in FIG. 8A after additional pressure has been applied by the practitioner's squeezing so that the inside curled surface of the distal tip of the first leg begins to push the inside curled surface of the distal tip of the second leg outward, the sliding locking mechanism being disengaged;

FIG. 8C represents the same view of the forceps depicted in FIG. 8B after still additional pressure has been applied by the practitioner's squeezing so that the forceps are fully closed and so that the inside curled surface of the distal tip of the first leg pushes the inside curled surface of the distal tip of the second leg fully outward, the sliding block locking mechanism being disengaged;

FIG. 8D represents the same view of the forceps depicted in FIG. 8C with the forceps being fully closed, the sliding block locking mechanism being engaged;

FIG. 9 depicts a dental forceps of the invention in which the distal tips are positioned at an angle that is opposite to the positioning of the distal tips in FIG. 1;

FIG. 10 depicts a dental forceps of the invention having a spring arm of a single piece locking mechanism mounted on the second leg of the forceps;

FIG. 11 is a perspective view of a dental forceps of the invention having a pawl of a pawl locking mechanism mounted on the forceps' second leg and biased to rotate toward the first ends of the forceps' legs;

FIG. 12 depicts a forceps of the invention having a pawl of a pawl locking mechanism mounted on the forceps' first leg and biased to rotate toward the first ends of the forceps' legs;

FIG. 13 depicts a forceps of the invention having a pawl of a pawl locking mechanism mounted on the forceps' first leg and biased to rotate toward the second ends of the forceps' legs;

FIG. 14 is a perspective view of a dental forceps of the invention having a single transverse notch extending along the width of the distal tip on the forceps' second leg;

FIG. 15 is a magnified view of the forceps of FIG. 14 depicting the forceps in their closed position, the forceps' distal tips gripping an object at the forceps' transverse notch; and

FIG. 16 is a magnified view of a forceps of the invention having a transverse notch extending along the width of the distal tip on the forceps' first leg.

### DETAILED DESCRIPTION OF THE PREFERRED EMBODIMENTS

Referring to the drawings, identical reference numbers designate the same or corresponding parts throughout the several figures shown in the drawings.

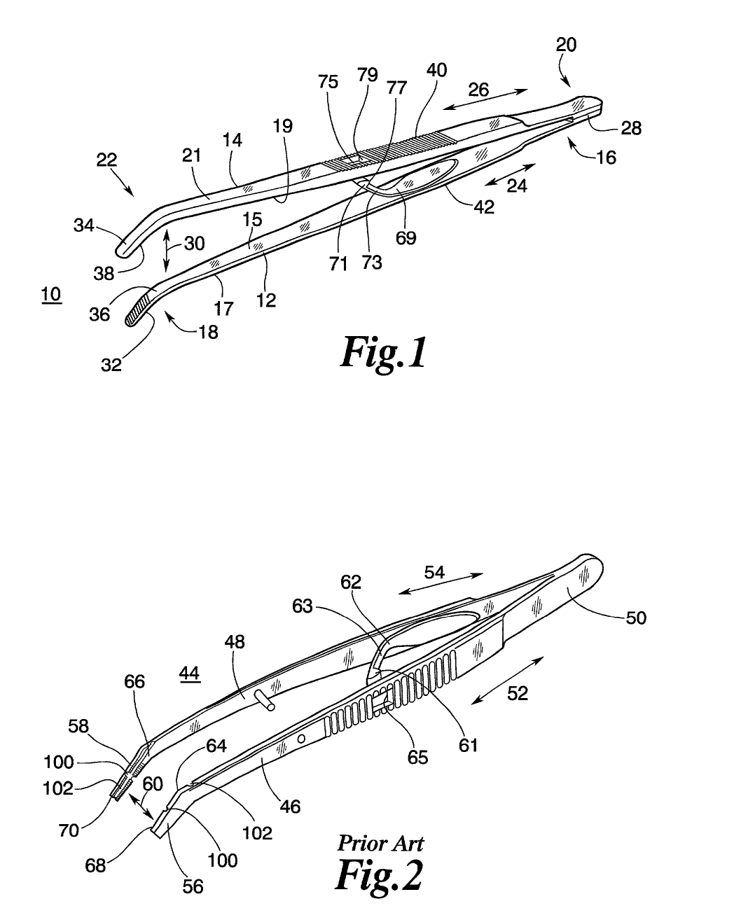

FIG. 1 depicts a pair of forceps 10 according to the invention having a first leg 12 and a second leg 14. The first leg 12 includes a first leg end 16 and a second leg end 18, and also includes an inside surface 15 and an outside surface 17. The second leg 14 includes a first leg end 20 and a second leg end 22, an inside surface 19, and an outside surface 21. FIG. 1 shows that the first leg 12 has an elongated major dimension 24 and the second leg 14 has an elongated major dimension 26 so that the major dimensions 24 and 26 define a longitudinal axis for legs 12 and 14, respectively. The axes of legs 12 and 14 meet at a point of springing interconnection 28 at a slight angle so that the second leg ends 18 and 22 are biased apart from each other leaving a gripping space 30. Any means of connection, such as a rivet, weld, or solid structuring can be used to join the first leg ends 16 and 20 so long as each of the second ends 18 and 22 remain springingly biased apart with a relative positioning that leaves a gripping space 30 between them.

The legs 12 and 14 may be constructed of any number of flexible materials. Generally, the material used will permit appropriate casting or molding of either the entire forceps apparatus or of the individual connectable components of the forceps assembly. In most cases, the material used will also be able to withstand high temperatures associated with sterilization or disinfecting processes as required for intrusive medical instruments. Such materials may include but are not limited to various metals and plastics or other polymers or synthetic materials. Materials having elastomeric properties may also be incorporated into the design to improve gripping comfort.

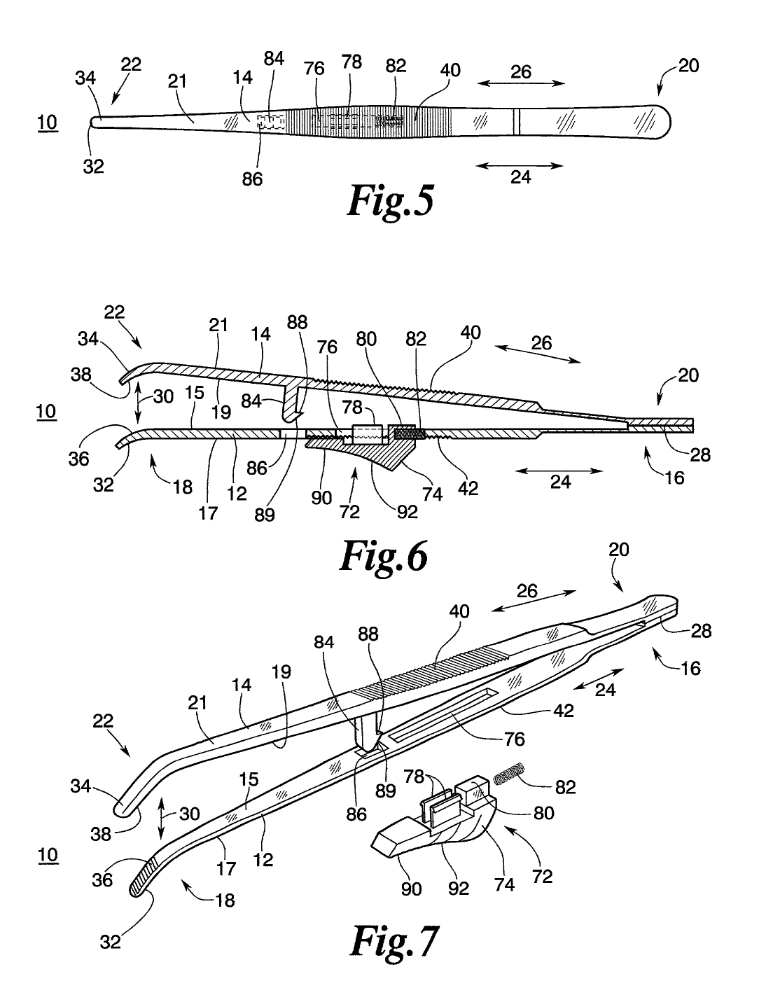

The longitudinal axes 24 and 26 defined by the major dimensions of first leg 12 and second leg 14 form a slight angle between the legs 12 and 14 extending from the point of springing interconnection 28. This angle formed by the axes defines a plane of orientation to which each of the legs 12 and 14 is substantially restricted. First gripping distal tip 32 and second gripping distal tip 34 extend, respectively, from each of the second leg ends 18 and 22 at an angle from each leg's respective longitudinal axis 24 or 26 but within the plane of orientation of the two legs. Thus, the distal tips 32 and 34 are oriented at an angle away from the outside surface 21 of the second leg 14 and toward the outside surface 17 of the first leg 12, creating a first curled inside surface 36 of distal tips 32 and a second curled inside surface 38 of distal tip 34 that face each other. The relative positioning of the curled inside surfaces 36 and 38 is best understood by comparing the perspective view of FIG. 1 with the top and side views of the forceps 10 of this invention shown in FIG. 5 and FIG. 6.

The positioning of the distal tips' curled inside surfaces 36 and 38 with respect to one another permits the tips 32 and 34 to exert gripping forces when external pressure is applied simultaneously to each of the legs 12 and 14. First leg 12 has an outside planar surface 42 and second leg 14 has an outside planar surface 40 to allow for squeezing against the biasing force of the springing interconnection 28. The planar surfaces 40 or 42 may be textured (as shown) in order to allow the practitioner to exert a tighter or more precise grip while squeezing. While the embodiment depicted in FIG. 1 shows a forceps 10 having this texturing as part of the formed planar surfaces 40 and 42, it will be appreciated that in some embodiments, the texturing can also be comprised of separate material elements attached directly to the planar surfaces 40 and 42. Such elements may appropriately comprise plastic, rubber, or similar composite materials.

When squeezed, pressure exerted against the legs 12 and 14 tends to move the inside surfaces 36 and 38 inward within the gripping space 30 so that a gripped object contacts the curled inside surfaces 36 and 38 directly. The downward squeezing motion of the legs 12 and 14 and angled positioning of the distal tips 32 and 34 permit the practitioner to operate the forceps 10 while maintaining the hand in a more comfortable and natural position. It is not necessary to unduly twist the wrist or fingers into an awkward or unnatural position for an extended period.

The relative orientation of the distal tips 32 and 34 allows for distinct structural and operational advantages which can be best understood by comparison with forceps of the prior art. FIG. 2 depicts a typical pair of prior art forceps 44 having a first leg 46 and a second leg 48 biased into an open position at a point of springing interconnection 50. In such previous designs, the first leg 46 has a major dimension 52 and the second leg 48 has a major dimension 54, the respective major dimension 52 and 54 defining longitudinal axes which interconnect at an angle at the point of springing interconnection 50 and which define a plane of orientation. The first leg 46 also ends in a distal tip 56 and the second leg 48 ends in a distal tip 58. However, unlike the distal tips 32 and 34 of forceps 10 of this invention, the distal tips 56 and 58 of prior art forceps 44 bend away from the plane of orientation while gripping objects in gripping space 60. As a result, the practitioner's wrist must be bent at an awkward angle to align fingers into a squeezing position while positioning distal tips 32 and 34 to a similar orientation.

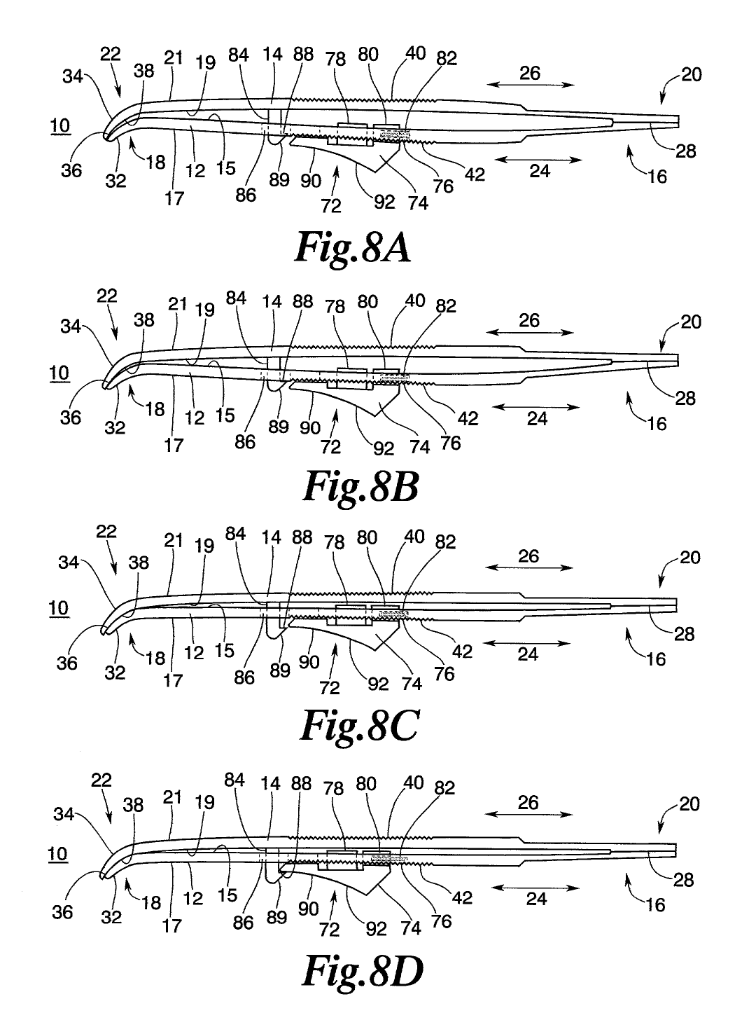

Other advantages of the invention relate to improved sensitivity while manipulating gripped objects. Unlike previous forceps such as those depicted in FIG. 2, a novel feature of the invention permits the distal tips 32 and 34 to move longitudinally or to slide, with respect to each other depending on the amount of pressure with which the practitioner squeezes, allowing for enhanced precision during use. To understand this operation, reference should first be made to FIG. 1 for comparison with FIGS. 8A-D. FIG. 1 depicts a pair of open forceps 10 that are not subjected to external pressure from squeezing and which are biased in their open position.

Referring now to FIG. 8A, an alternative embodiment of the forceps 10 are depicted while being squeezed slightly so that the curled inside surfaces 36 and 38 of the gripping distal tips 32 and 34 make slight contact. The distal tip 34 of the second leg 14 has not yet moved along the leg's longitudinal axis 26 with respect to the distal tip 32 of the first leg 12.

Depending on the object being manipulated, the practitioner may wish to exert additional pressure by squeezing harder at planar surfaces 40 and 42 against the biasing force on legs 12 and 14. FIG. 8B depicts the effect of a slight increase in the squeezing force that the practitioner exerts against the legs 12 and 14. As a result of the additional pressure, the distal tip 34 of the second leg 14 pushes downward against the distal tip 32 of the first leg 12, forcing the distal tip 34 of the second leg 14 to slide outward along the leg's longitudinal axis 26. This sliding motion results in a slight springlike bending of the second leg 14, the extent of which is dependent on the amount of pressure the practitioner exerts against the legs 12 and 14. As the distal tip 34 of the leg 14 slides over the distal tip 32 of the first leg 12, the practitioner is able to adjust the tactile sensitivity of the gripping motion as necessary without substantially reducing the gripping force exerted.

As the practitioner continues to squeeze with additional force, the distal tip 34 of the leg 14 continues to slide over the distal tip 32 of the first leg 12 until it is fully extended as shown in FIG. 8C. At this point, the practitioner can continue adjusting the gripping force by reducing the squeeze exerted against the legs 12 and 14, thereby permitting the springing action of the second leg 14 and the biasing force of the springing interconnection 28 to retract the distal tip 34 with respect to the distal tip 32.

The forceps of this invention can be used as described above without a lock. Alternatively, the illustrated embodiments of the invention allow the practitioner to lock the forceps 10 so that they will remain closed when the practitioner releases the squeezing action entirely. The invention presents additional advantages due to some inherent characteristics of its design. These advantages are best understood when compared to previous designs such as the forceps 44 depicted in FIG. 2. The prior art forceps 44 include a first leg 46 having a leg end 64 and a distal end 56 and a second leg 48 having a leg end 66 and a distal end 58. A single-piece locking mechanism 62 includes a locking head 61 positioned at the end of a spring arm 63 extending from the second leg 48, and a locking hole 65 extending through the first leg 46.

The prior art forceps leg ends 64 and 66 are configured so that when a practitioner fully squeezes prior art forceps legs 48 and 46, the first distal end 56 and second distal end 58 exert their gripping force against objects located within gripping space 60. At this point, the locking head 61 enters and locks inside of the locking hole 65, locking the forceps 44 in the closed position. However, since the inside surfaces of the distal ends 56 and 58 are substantially parallel with the adjacent inside surfaces of the legs 48 and 46, gripping forces tend to be exerted most tightly at a rolling fulcrum point between the first leg end 64 and second leg end 66, particularly if the locking mechanism 62 engages or if the practitioner squeezes the legs 46 and 48 tightly. If the practitioner exerts additional pressure, the effect of the rolling fulcrum between the leg ends 64 and 66 tends to force the outermost end 68 of distal tip 56 and outermost end 70 of distal tip 58 away from each other. As a result, slight clearances can exist between the distal tips 56 and 58, especially near the outermost ends 68 and 70. Such clearances can reduce the ability of the forceps to grasp smaller diameter items such as dental floss or articulating film.

A similar single piece locking mechanism can also be incorporated into the invention as depicted in the embodiment in FIG. 1. The locking mechanism 69 includes a locking head 71 having an undercut 77 and positioned at the end of a spring arm 73 extending from the inside surface 15 of the first leg 12. A locking hole 75 having an engagement edge 79 extends through the second leg 14. The locking head 71 is positioned so that when a practitioner fully squeezes the forceps legs 12 and 14, the locking head 71 contacts the inside surface 19 of the second leg 14, compressing the spring arm 69 which flexibly slides the locking head 71 toward the legs' second ends 18 and 22. This sliding motion of the locking head 71 allows the head's undercut 77 to clear the engagement edge 79 of the locking hole 75 to permit the locking head 71 to pass into the locking hole 75 under the compression force of the spring arm 73. When a practitioner releases squeezing pressure against the legs 12 and 14, the compression force of the spring arm 73 is also released. However, the undercut 77 of the locking head 71 catches against the engagement edge 79 of the locking hole 75, locking the forceps 10 in the locked position. When the forceps 10 are locked, much of the locking head 71 remains above the planar surface 40 of the second leg 14. While handling the forceps 10 at the planar surfaces 40 and 42, the practitioner can easily unlock the forceps 10 by sliding one finger forward against the exposed undercut 77 of the locking head 71 so that the undercut 77 again clears the engagement edge 79 and the locking head 71 passes through the locking hole 75.

It will be appreciated that such a locking mechanism 69 could be affixed to the forceps 10 of the invention in alternate ways. For example, the locking mechanism 69 could be arranged so that the spring arm 73 and locking head 71 extend from the second leg 14. In such an embodiment, as depicted in FIG. 10, the locking hole 75 is positioned on the first leg 12.

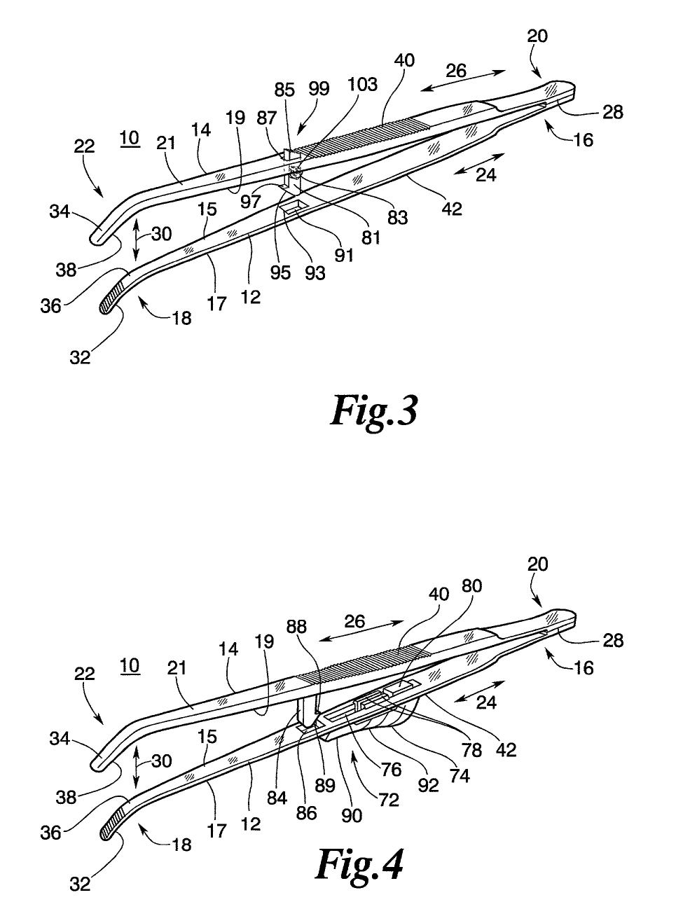

Other locking mechanisms can also be used with the forceps 10. Referring to FIG. 3, one alternate embodiment of the invention includes a pawl locking mechanism 99 having a spring-operated pawl 81 that is mounted on a pivot 83 on the second leg 14 of the forceps 10. The pawl 81 has a tapered release surface 85 which extends through an operating space 87 in the second leg 14 and which is adjacent to the second leg's outside planar surface 40. A locking hole 91 having an engagement edge 93 extends through the first leg 12. The pawl 81 is biased with a spring 103 to rotate on its pivot 83 in a direction that is generally toward the second ends 18 and 22 of the legs 12 and 14. When fully rotated in this direction, the pawl assumes a biased position (shown in FIG. 3). It will be appreciated that the spring 103 can have a circular, leaf spring, or other construction so long as the pawl is spring biased to a biased position. The pawl 81 also includes a tapered end 95 and an undercut 97 for locking the forceps 10 after the forceps 10 are squeezed fully.

As the practitioner squeezes the forceps 10, the pawl 81 begins to contact the engagement edge 93 of the locking hole 91 at the pawl's tapered end 95. The angled shape of the tapered end 95 causes the pawl 81 to rotate on its pivot 83 as the practitioner applies progressive amounts of squeezing force. This rotational movement is against the biasing force of the pawl's spring 103. When the practitioner squeezes the forceps 10 fully, the pawl 81 rotates sufficiently to clear the engagement edge 93 and the pawl 81 enters the locking hole 91. Once the pawl 81 has entered the locking hole 91, the biasing force of the pawl's spring 103 pushes the undercut 97 of the pawl 81 under the engagement edge 93, securing the forceps 10 in their locked position.

To unlock the forceps 10 using this pawl locking mechanism 99, the practitioner need only extend one finger from the second leg's planar surface 40 to the tapered release surface 85. This can normally be done with a single finger stroke and without releasing the practitioner's grip due to the proximity of the second leg's planar surface 40 to the release surface 85 of the pawl. In pressing the release surface 85, the practitioner rotates the pawl 81 on its pivot 83 against the biasing force of the pawl's spring 103, allowing the pawl's undercut 97 to clear the engagement edge 93 and pass out of the locking hole 91, unlocking the forceps 10.

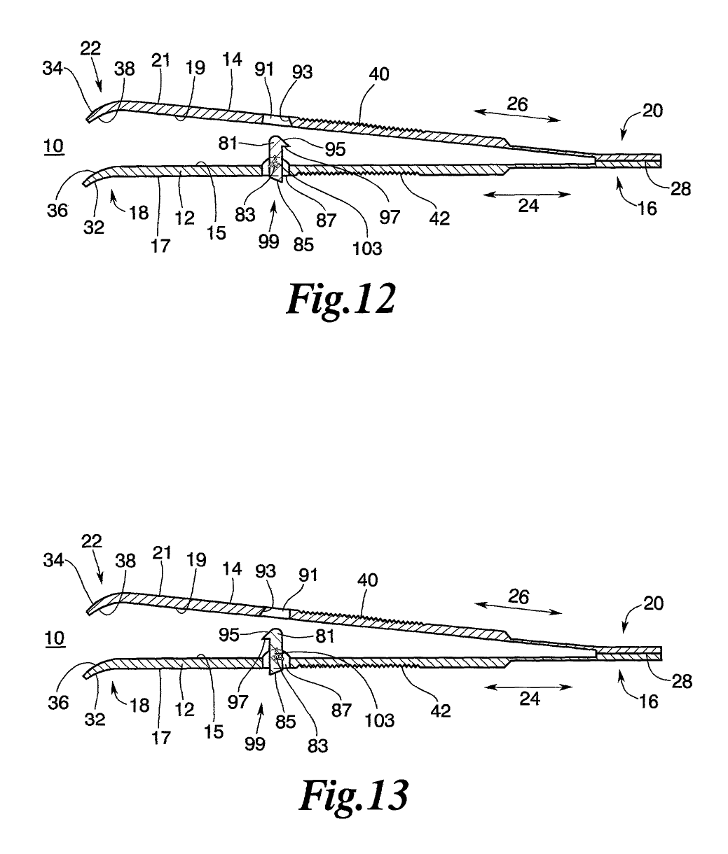

It will be appreciated that a pawl locking mechanism 99 can also be affixed to the forceps 10 of the invention in alternate ways. Referring to FIG. 11, the pawl locking mechanism 99 could be arranged so that the pawl 81 is biased to rotate away from the second ends 18 and 22 and toward the first ends 16 and 20 of the legs 12 and 14. In this embodiment, the undercut 97 of the pawl 81 would be positioned to extend away from the second ends 18 and 22 and toward the first ends 16 and 20. In pressing the tapered release surface 85, the practitioner rotates the pawl 81 toward the legs' second ends 18 and 22 to clear the engagement edge 93 and unlock the forceps 10. FIGS. 12 and 13 also depict embodiments having pawl locking mechanisms 99 similar to the embodiments depicted in FIG. 3 and FIG. 11, but each having its pawl 81 pivotally mounted to the first leg 12 of its respective forceps 10. In each of these embodiments, the locking hole 91 extends through the second leg 40 of the forceps 10. The pawl 81 is thus released by extending the practitioner's fingers from the first leg's planar surface 42 to the tapered release surfaces 85.

Another possible locking mechanism incorporates the use of a spring-loaded, sliding block. This sliding block locking mechanism 72 contemplated by the invention includes a spring-loaded locking block 74 that is inserted to slide axially, or back and forth along the first leg's longitudinal axis, into a lock slot 76. Additional detail of the mechanism's construction and operation is best understood with reference to the exploded view of the sliding block locking mechanism 72 in FIG. 7. The locking block 74 includes twin engagement flanges 78 for securing the locking block 74 in the lock slot 76 and an end stop 80 for restricting retraction of the locking block 74 against a compression spring 82. An alignment post 84 extends from the inside surface 19 of the second leg 14 so that during compression of the legs 12 and 14, the alignment post 84 extends through an alignment hole 86 in the first leg 12. The alignment post 84 includes an undercut 88 for engaging a locking surface 90 on the locking block 74. The undercut 88 has an inclined surface 89 for engaging and compressing the locking block 74 against the compression spring 82 and for automatically locking the forceps 10 into a locked position when the forceps 10 are fully compressed. Such a locked position is depicted in FIG. 8D. Once closed in the locked position, a contoured lower surface 92 on the locking block 74 permits the practitioner to compress the locking block 74 against the compression spring 82, as shown in FIGS. 8A-C, to release the gripping action of the forceps 10.

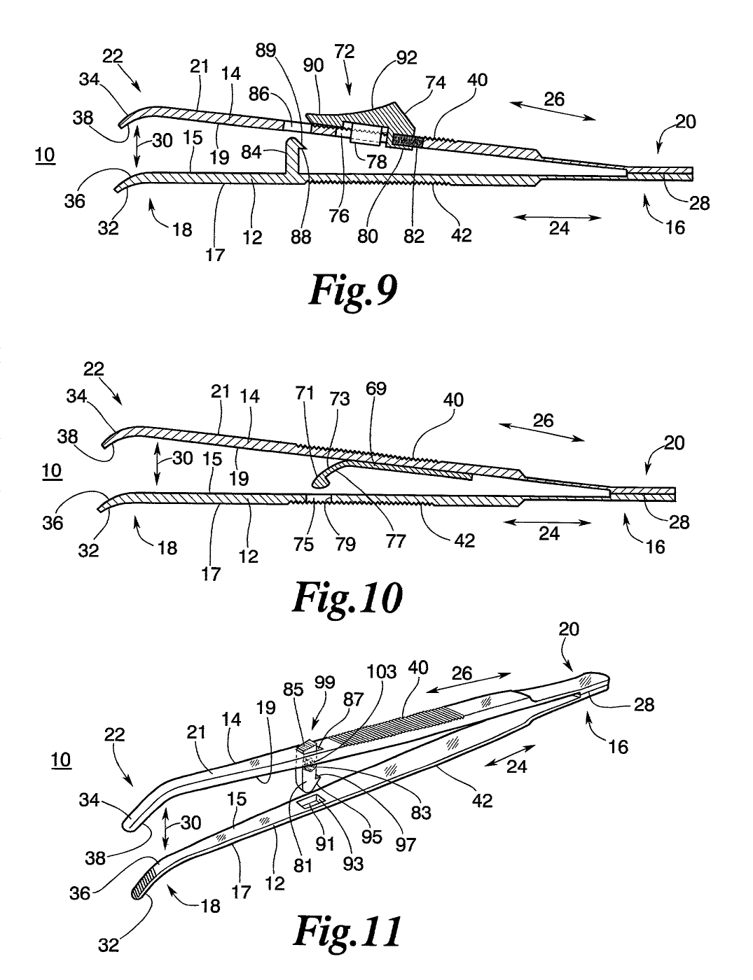

In some embodiments, such as the embodiment depicted in FIG. 9, the positioning of the sliding block locking mechanism 72 can be arranged so that the locking block 74 slides axially on the second leg 14 instead of the first leg 12 of the forceps 10. In these embodiments, the alignment hole 86 also extends through the second leg 14 while the alignment post 84 extends from the inside surface 15 of the first leg 12. Here, while the angular positioning of the distal tips 32 and 34 with respect to the sliding block locking mechanism 72 is opposite to the relative distal tip positioning in the embodiment of FIG. 4, it will be appreciated that either embodiment as well as other variations may be appropriately implemented without departing from the scope of this invention.

It will also be appreciated that while the embodiments shown and described include various locking mechanisms, forceps having a other locking mechanisms or that lack any locking feature are also contemplated to be within the scope of the invention.

The embodiments of the invention shown herein do not present the inter-distal tip clearance problems associated with previous designs such as the prior art forceps 44 of FIG. 2. As shown in FIG. 8A, when a practitioner exerts sufficient squeezing force to draw the gripping distal tips 32 together, the curled inside surfaces 36 and 38 initially make slight contact. As shown in FIG. 8B, additional pressure forces the distal tip 34 of the second leg 14 downward against the distal tip 32 of the first leg 12, forcing the distal tip 34 of the second leg 14 to move longitudinally outward along the leg's longitudinal axis 26. This has the effect of increasing the amount of rolled surface area in which the curled inside surfaces 36 and 38 may come into contact. As noted above, if the curled inside surfaces 36 and 38 touch, a larger amount of force causes the second leg's distal tip 34 to slide relative to the distal tip 32 of the first leg 12 until it is fully extended as shown in FIG. 8C. Thus, FIGS. 8A-C demonstrate that additional squeezing pressure forces the curled inside surfaces 36 and 38 of the first leg 12 and second leg 14 to increase the amount of rolled surface area at which the legs 12 and 14 are in contact. This characteristic of the invention substantially reduces the effect of clearances between the distal tips 32 and 34 that might otherwise tend to result from the practitioner's excessive squeezing, from manipulation of the forceps 10 such as in FIGS. 8A-C, or from placing the forceps 10 in their locked position such as in FIG. 8D.

This characteristic also permits the invention to incorporate gripping notches into the forceps' design. This is best understood by first referring to the prior art forceps 44 of FIG. 2. In such previous designs, a transverse notch 100 extends along the width and a longitudinal notch 102 extends along the length of each distal tip 56 and 58. Each transverse notch 100 is opposite to a corresponding transverse notch 100 on the opposite distal tip 56 or 58. When the forceps 44 are closed, the opposite transverse notches 100 form a larger surrounding notch, extending the width of the distal tips 56 and 58. Each longitudinal notch 102 also has a corresponding longitudinal notch 102. Together, the longitudinal notches 102 form a larger surrounding notch extending the length of the distal tips 56 and 58 when the forceps 44 are closed. The larger notches formed by the closed transverse notches 100 and longitudinal notches 102 permit the practitioner to exercise precise and rigid grasping of very thin dental elements such as pins and flosses. However, in order for proper gripping to occur, a gripped object must have an identical or larger sized diameter than the larger surrounding notch of the combined transverse notches 100 or longitudinal notches 102 and must also simultaneously fit into the lines of both opposing transverse notches 100 or of both opposing longitudinal notches 102.

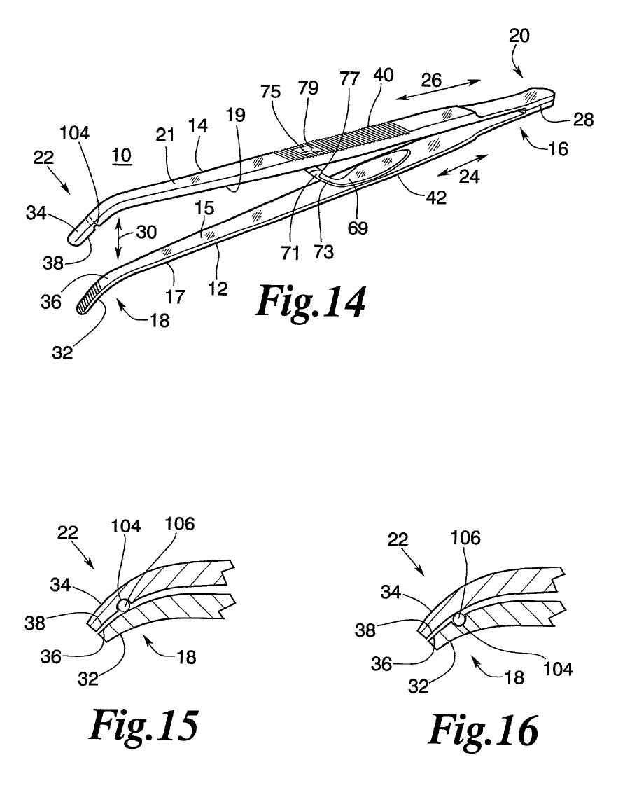

For comparison with the prior art forceps 10 of FIG. 2, FIG. 14 depicts an embodiment of the invention having a single transverse notch 104 extending the width of the distal tip 34 of the second leg 14. A magnified view of the distal tips 32 and 34 is depicted in FIG. 15, the distal tips 32 and 34 shown gripping the cylindrical section of a gripped object 106. As shown in FIG. 15, the notch 104 can be sufficiently large to accommodate a substantial cross-sectional portion of a gripped object 106. When the practitioner squeezes the legs 12 and 14 of the forceps 10, the curled inside surface 36 of the of the first leg's distal tip 32 presses the gripped object 106 against the notch 104 in the second leg's distal tip 34. Thus, unlike previous forceps, the forceps 10 of FIG. 15 require only that the object 106 be in line with and have the diameter of a single notch 104 in order to be gripped. As the distal tips 32 and 34 slide with respect to each other during the gripping action, the gripped object 106 is free to slide along the curled inside surface 36 of the first leg's distal tip 32 while the single notch 104 secures the gripped object 106 in position.

While FIG. 15 depicts a forceps 10 having a notch 104 positioned on the distal tip 34 of the forceps' second leg 14, it will be appreciated that a similar, single notch 104 could be also be positioned in other locations and remain within the scope of the invention. For example, FIG. 16 is a magnified view of an alternate embodiment forceps 10 in which a single notch 104 extends across the width of the distal tip 32 of the forceps' first leg 12. In this embodiment, when the distal tips 32 and 34 slide with respect to each other during the gripping operation, the gripped object 106 slides across the curled inside surface 38 of the second leg's distal tip 34, the object 106 being secured in place by the distal tip 32 of the forceps' first leg 12.

Those skilled in the art will recognize that the various features of this invention described above can also be used in various combinations with other elements without departing from the scope of the invention. This invention has been explained with respect to the details, arrangements of components, and certain specific embodiments shown in the accompanying drawings. Many modifications can be made by those skilled in the art without departing from the spirit and scope of this invention. Thus, the appended claims are intended to be interpreted to cover such equivalent dental forceps that do not depart from the spirit and scope of the invention.

1. A dental forceps comprising:
a first leg and a second leg, each leg having an inside surface, an outside surface and a longitudinal axis;
said longitudinal axes of said first and second legs defining a plane of orientation of said legs, each said leg terminating in first and second leg ends, said first leg end of said first leg in springing connection with said first leg end of said second leg, said second leg ends of said first and second legs being springingly biased apart from each other to place said forceps in an open position in the absence of pressure being applied on said outside surfaces of said first and second legs;
each of said second leg ends on said first and second legs having a gripping distal tip oriented at an angle from the longitudinal axis of said legs toward said outside surface of said first leg and away from said outside surface of said second leg and approximately within said plane of orientation; and
each distal tip having a curled inside surface; a gripping space existing between said curled inside surfaces when said forceps are in the open position; the simultaneous application of pressure on said outside surfaces of said first and second legs resulting in the squeezing of said first and second leg ends toward one another so as to cause a gripping action to be exerted by said curled inside surfaces of said distal tips as said forceps are placed in a closed position.

2. The dental forceps of claim 1 wherein manual squeezing of said first and second legs into the closed position also results in relative longitudinal motion between said curled inside surfaces of said distal tips for enhanced operator control of the resulting gripping action.

3. The dental forceps of claim 1 further comprising texturing along said curled inside surfaces of said distal tips for increasing frictional forces that result from gripping action.

4. The dental forceps of claim 1 further comprising:
an alignment hole extending approximately through the longitudinal axis of said first leg; and
an alignment pin positioned on the inside surface of said second leg and approximately normal to said second leg's longitudinal axis, said alignment pin being positioned to enter said alignment hole and to extend through said first leg when said first and second legs are squeezed together, thereby maintaining alignment of said first and second legs during the gripping action.

5. The dental forceps of claim 1, said forceps having a textured gripping surface on said outside surfaces of said first and second legs.

6. The dental forceps of claim 1 further including a self locking mechanism positioned between said first and second legs, said self locking mechanism configured to automatically lock and maintain said forceps in their locked position when said first and second legs are squeezed fully.

7. The dental forceps of claim 1 further including a self locking mechanism comprising:
a spring arm and a locking head having an undercut, said spring arm extending from said inside surface of one of said first and second legs, said locking head positioned at the end of said spring arm;
a locking hole having an engagement edge extending through the opposite of said one of said first and second legs;
said locking head being positioned so that when said first and second legs are fully squeezed, said locking head contacts said inside surface of said opposite of said one of said first and second legs, thereby compressing said spring arm and flexibly sliding said locking head to clear said engagement edge of said locking hole to allow said locking head to pass into said locking hole under the compression force of said spring arm; and
said locking head also being positioned so that said undercut of said locking head engages said engagement edge of said locking hole when said locking head enters said locking hole, thereby locking and maintaining said forceps in their locked position.

8. The dental forceps of claim 1 further including a self locking mechanism comprising:
a spring arm and a locking head having an undercut, said spring arm extending from said inside surface of said first leg, said locking head positioned at the end of said spring arm;
a locking hole having an engagement edge extending through said second leg; and
said locking head being positioned so that when said first and second legs are fully squeezed, said locking head contacts said inside surface of said second leg, thereby compressing said spring arm and flexibly sliding said locking head to clear said engagement edge of said locking hole to allow said locking head to pass into said locking hole under the compression force of said spring arm;
said locking head also being positioned so that said undercut of said locking head engages said engagement edge of said locking hole when said locking head enters said locking hole, thereby locking and maintaining said forceps in their locked position.

9. The dental forceps of claim 1 further including a self locking mechanism comprising:
a spring arm and a locking head having an undercut, said spring arm extending from the inside surface of said second leg, said locking head positioned at one end of said spring arm;
a locking hole having an engagement edge extending through said first leg;
said locking head being positioned so that when said first and second legs are fully squeezed, said locking head contacts said inside surface of said first leg, thereby compressing said spring arm and flexibly sliding said locking head to clear said engagement edge of said locking hole to allow said locking head to pass into said locking hole under the compression force of said spring arm; and
said locking head also being positioned so that said undercut of said locking head engages said engagement edge of said locking hole when said locking head enters said locking hole, thereby locking and maintaining said forceps in their locked position.

10. The dental forceps of claim 1 further including a pawl locking mechanism comprising:
an operating space extending through said second leg of said forceps;
a pivot having a pawl mounted thereon, said pivot mounted on one of said first and second legs of said forceps, said pawl having an undercut, a tapered end and a tapered release surface, said tapered release surface extending through said operating space, said pawl being biased to rotate in one direction;
a locking hole having an engagement edge extending through one of said first and second legs opposite to said pawl;
said pawl being mounted so that when said first and second legs are fully squeezed, said tapered end of said pawl contacts said inside surface of the oppositely positioned one of said first or second legs, thereby causing said pawl to rotate on said pivot against the pawl's bias, permitting said undercut to clear said engagement edge of said locking hole and thereby allowing said pawl to pass into said locking hole; and
said pawl also being positioned so that when said pawl enters said locking hole, said pawl rotates on said pivot under the biasing force of said pawl, said engagement edge of said locking hole engaging said undercut of said pawl, thereby locking and maintaining said forceps in their locked position.

11. The dental forceps of claim 1 further including a pawl locking mechanism comprising:
an operating space extending through said second leg of said forceps;
a pawl mounted on a pivot on said second leg of said forceps, said pawl having an undercut, a tapered end and a tapered release surface, said tapered release surface extending through said operating space of said second leg, said pawl also being biased to rotate generally toward said second leg ends;
a locking hole having an engagement edge extending through said first leg;
said pawl being positioned so that when said first and second legs are fully squeezed, said tapered end of said pawl contacts said inside surface of said first leg, thereby causing said pawl to rotate on said pivot toward said first ends of said legs, thereby permitting said undercut to clear said engagement edge of said locking hole and thereby allowing said pawl to pass into said locking hole; and
said pawl also being positioned so that when said pawl enters said locking hole, said pawl rotates on said pivot toward said second ends of said forceps under the biasing force of said pawl, said engagement edge of said locking hole engaging said undercut of said pawl, thereby locking and maintaining said forceps in their locked position.

12. The dental forceps of claim 1 further including a pawl locking mechanism comprising:
an operating space extending through said second legs of said forceps;
a pawl mounted on a pivot on said second legs of said forceps, said pawl having an undercut, a tapered end and a tapered release surface, said tapered release surface extending through said operating space of said second leg, said pawl also being biased to rotate generally toward said first leg ends;
a locking hole having an engagement edge extending through said first leg;
said pawl being positioned so that when said first and second legs are fully squeezed, said tapered end of said pawl contacts said inside surface of said first leg, thereby causing said pawl to rotate on said pivot toward said second ends of said legs, thereby permitting said undercut to clear said engagement edge of said locking hole and thereby allowing said pawl to pass into said locking hole; and
said pawl also being positioned so that when said pawl enters said locking hole, said pawl rotates on said pivot toward said first ends of said forceps under the biasing force of said pawl, said engagement edge of said locking hole engaging said undercut of said pawl, thereby locking and maintaining said forceps in their locked position.

13. The dental forceps of claim 1 further including a pawl locking mechanism comprising:
an operating space extending through said first leg of said forceps;
a pawl mounted on a pivot on said first leg of said forceps, said pawl having an undercut, a tapered end and a tapered release surface, said tapered release surface extending through said operating space of said first leg, said pawl also being biased to rotate generally toward said first leg ends;
a locking hole having an engagement edge extending through said second leg;
said pawl being positioned so that when said first and second legs are fully squeezed, said tapered end of said pawl contacts said inside surface of said second leg, thereby causing said pawl to rotate on said pivot toward said second ends of said legs, thereby permitting said undercut to clear said engagement edge of said locking hole and thereby allowing said pawl to pass into said locking hole; and
said pawl also being positioned so that when said pawl enters said locking hole, said pawl rotates on said pivot toward said first ends of said forceps under the biasing force of said pawl, said engagement edge of said locking hole engaging said undercut of said pawl, thereby locking and maintaining said forceps in their locked position.

14. The dental forceps of claim 1 further including a pawl locking mechanism comprising:
an operating space extending through said first leg of said forceps;
a pawl mounted on a pivot on said first leg of said forceps, said pawl having an undercut, a tapered end and a tapered release surface, said tapered release surface extending through said operating space of said first leg, said pawl also being biased to rotate generally toward said second leg ends;
a locking hole having an engagement edge extending through said second leg;
said pawl being positioned so that when said first and second legs are fully squeezed, said tapered end of said pawl contacts said inside surface of said first second, thereby causing said pawl to rotate on said pivot toward said first ends of said legs, thereby permitting said undercut to clear said engagement edge of said locking hole and thereby allowing said pawl to pass into said locking hole; and
said pawl also being positioned so that when said pawl enters said locking hole, said pawl rotates on said pivot toward said second ends of said forceps under the biasing force of said pawl, said engagement edge of said locking hole engaging said undercut of said pawl, thereby locking and maintaining said forceps in their locked position.

15. The dental forceps of claim 1 further including a sliding block locking mechanism comprising:
a locking block having a locking surface, said locking block being attached to one of said first and second legs and being attached to slide axially thereon;
an alignment hole adjacent to said locking block and extending approximately through the longitudinal axis of said one of said first and second legs;
an alignment post having an undercut surface, said alignment post positioned on the inside surface of the opposite of said one of said first and second legs and approximately normal to the longitudinal axis of one of said first and second legs, said alignment post being positioned to enter said alignment hole when said first and second legs are squeezed together; and
said locking block being positioned so that said locking block can slidably engage said undercut surface of said alignment post when said dental forceps are fully closed for locking and maintaining said dental forceps in their locked position.

16. The dental forceps of claim 1 further including a sliding block locking mechanism comprising:
a locking block having a locking surface, said locking block being attached to said first leg and being attached to slide axially thereon;
an alignment hole extending approximately through the longitudinal axis of said first leg;
an alignment post having an undercut surface, said alignment post positioned on the inside surface of said second leg and approximately normal to said second leg's longitudinal axis, said alignment post being positioned to enter said alignment hole and to extend through said first leg when said first and second legs are squeezed together; and
said locking block being positioned so that said locking block can slidably engage said undercut surface of said alignment post when said dental forceps are fully closed for locking and maintaining said dental forceps in their locked position.

17. The dental forceps of claim 1 further including a sliding block locking mechanism comprising:
a locking block having a locking surface, said locking block being attached to said second leg and being attached to slide axially thereon;
an alignment hole extending approximately through the longitudinal axis of said second leg;
an alignment post having an undercut surface, said alignment post positioned on the inside surface of said first leg and approximately normal to said first leg's longitudinal axis, said alignment post being positioned to enter said alignment hole and to extend through said second leg when said first and second legs are squeezed together; and
said locking block being positioned so that said locking block can slidably engage said undercut surface of said alignment post when said dental forceps are fully closed for locking and maintaining said dental forceps in their locked position.

18. The dental forceps of claim 1 further including a sliding block locking mechanism comprising:
a locking block having a locking surface, said locking block being attached to said first leg and being attached to slide axially thereon;
an alignment hole extending approximately through the longitudinal axis of said first leg;
an alignment post having an undercut surface, said alignment post positioned on the inside surface of said second leg and approximately normal to said second leg's longitudinal axis, said alignment post being positioned to enter said alignment hole and to extend through said first leg when said first and second legs are squeezed together; and
said locking block having a compression spring for biasing said locking surface of said locking block to engage said undercut surface of said alignment post when said dental forceps are fully closed for maintaining said dental forceps in their locked position.

19. The dental forceps of claim 1 further including a sliding block locking mechanism comprising:
a locking block having a locking surface, said locking block being attached to said second leg and being attached to slide axially thereon;
an alignment hole extending approximately through the longitudinal axis of said second leg;
an alignment post having an undercut surface, said alignment post positioned on the inside surface of said first leg and approximately normal to said first leg's longitudinal axis, said alignment post being positioned to enter said alignment hole and to extend through said second leg when said first and second legs are squeezed together; and
said locking block having a compression spring for biasing said locking surface of said locking block to engage said undercut surface of said alignment post when said dental forceps are fully closed for locking and maintaining said dental forceps in their locked position.

20. The dental forceps of claim 1 further including a transverse notch, said notch extending along the width of said curled inside surface of said distal tip of said second leg for precise and rigid gripping of thin objects.

21. The dental forceps of claim 1 further including a transverse notch, said notch extending along the width of said curled inside surface of said distal tip of said first leg for precise and rigid gripping of thin objects.

22. A dental forceps comprising:
a first leg and a second leg, each leg having an inside surface, an outside surface and a longitudinal axis;
said longitudinal axes of said first and second legs defining a plane of orientation of said legs, each said leg terminating in first and second leg ends, said first leg end of said first leg in springing connection with said first leg end of said second leg, said second leg ends of said first and second legs being springingly biased apart from each other to place said forceps in an open position in the absence of pressure being applied on said outside surfaces of said first and second legs;
each of said second leg ends on said first and second legs having a gripping distal tip oriented at an angle from the longitudinal axis of said legs toward said outside surface of said first leg and away from said outside surface of said second leg and approximately within said plane of orientation;
each distal tip having a curled inside surface; a gripping space existing between said curled inside surfaces when said forceps are in the open position; the simultaneous application of pressure on said outside surfaces of said first and second legs resulting in the squeezing of said first and second leg ends toward one another so as to cause a gripping action to be exerted by said curled inside surfaces of said distal tips as said forceps are placed in a closed position; and
a locking mechanism positioned between said first and second legs and configured to lock and maintain said dental forceps in their locked position when said dental forceps are fully closed.

23. A dental forceps comprising:
a first leg and a second leg, each leg having an inside surface, an outside surface and a longitudinal axis;
said longitudinal axes of said first and second legs defining a plane of orientation of said legs, each said leg terminating in first and second leg ends, said first leg end of said first leg in springing connection with said first leg end of said second leg, said second leg ends of said first and second legs being springingly biased apart from each other to place said forceps in an open position in the absence of pressure being applied on said outside surfaces of said first and second legs;
each of said second leg ends on said first and second legs having a gripping distal tip oriented at an angle from the longitudinal axis of said legs toward said outside surface of said first leg and away from said outside surface of said second leg and approximately within said plane of orientation;
each distal tip having a curled inside surface; a gripping space existing between said curled inside surfaces when said forceps are in the open position; the simultaneous application of pressure on said outside surfaces of said first and second legs resulting in the squeezing of said first and second leg ends toward one another so as to cause a gripping action to be exerted by said curled inside surfaces of said distal tips as said forceps are placed in a closed position;
said forceps being configured so that manual squeezing of said first and second legs into the closed position also results in longitudinal motion between said curled inside surfaces of said distal tips for enhanced operator control of the resulting gripping action;
said curled inside surfaces of said distal tips being textured for increasing frictional forces that result from the resulting gripping action; and
each of said forceps having a textured gripping surface on said outside surfaces of said first and second legs.

24. A dental forceps comprising:
a first leg and a second leg, each leg having an inside surface, an outside surface and a longitudinal axis;
each said leg terminating in first and second leg ends, said first leg end of said first leg in springing connection with said first leg end of said second leg, said second leg ends of said first and second legs being springingly biased apart from each other to place said forceps in an open position in the absence of pressure being applied on said outside surfaces of said first and second legs;
a locking block having a locking surface, said locking block being attached to one of said first and second legs and being attached to slide axially thereon;
an alignment hole extending approximately through the longitudinal axis of one of said first and second legs;
an alignment post having an undercut surface, said alignment post positioned opposite to said alignment hole and approximately normal to the longitudinal axis of one of said first and second legs, said alignment post being positioned to enter said alignment hole and to extend through one of said first and second legs when said first and second legs are squeezed together; and
said locking block having a compression spring for biasing said locking surface of said locking block to engage said undercut surface when said dental forceps are fully closed for locking and maintaining said dental forceps in their locked position.

25. A dental forceps comprising:
a first leg and a second leg, each said leg having an inside surface, an outside surface and a longitudinal axis;
each said first and second leg terminating in first and second leg ends, said first leg end of said first leg in springing connection with said first leg end of said second leg, said second leg ends of said first and second legs being springingly biased apart from each other to place said forceps in an open position in the absence of pressure being applied on said outside surfaces of said first and second legs;
an operating space extending through one of said first or second legs of said forceps;
a pivot having a pawl mounted thereon, said pivot being mounted adjacent to said operating space, said pawl having an undercut, a tapered end and a tapered release surface, said tapered release surface extending through said operating space to said outside surface of one of said first and second arms, said pawl also being biased to rotate generally in one direction;
a locking hole having an engagement edge extending through one of said first or second legs opposite of said pawl;
said pawl being positioned so that when said first and second legs are fully squeezed, said tapered end of said pawl contacts an oppositely positioned said inside surface of one of said first or second legs, thereby causing said pawl to rotate on said pivot against the pawl's bias, permitting said undercut to clear said engagement edge of said locking hole and thereby allowing said pawl to pass into said locking hole; and
said pawl also being positioned so that when said pawl enters said locking hole, said pawl rotates on said pivot under the biasing force of said pawl, said engagement edge of said locking hole engaging said undercut of said pawl, thereby locking and maintaining said forceps in their locked position.
